(19) United States
(12) Patent Application Publication
(10) Pub. No.: US 2014/0028768 A1
(43) Pub. Date: Jan. 30, 2014

(54) METHOD AND SYSTEM FOR PRINTING UNTREATED TEXTILE IN AN INKJET PRINTER

(71) Applicant: Meijet Coating and Inks, Inc., Shanghai (CN)

(72) Inventor: Wen Chen, San Diego, CA (US)

(73) Assignee: Meijet Coating and Inks, Inc., Shanghai (CN)

(21) Appl. No.: 14/039,409

(22) Filed: Sep. 27, 2013

Related U.S. Application Data
(63) Continuation-in-part of application No. 13/475,844, filed on May 18, 2012.

(51) Int. Cl. B41J 3/407

(52) U.S. Cl. CPC B41J 3/4078
USPC 347/102

(57) ABSTRACT

A method and system for printing untreated textile media in an inkjet printer for sharp image quality is disclosed. The method comprises printing untreated textile media with an aqueous dye-based textile ink selected according to the type of the textile media, and heating the printed textile media above a predetermined media temperature limit in the print zone to evaporate the ink moisture. The method further comprises maintaining printhead temperature by circulating a coolant through a channel in a plate that is conductively attached to the printhead for nozzle healthiness, and driving the untreated textile media with an endless belt to control stretching and distortion.

### CROSS REFERENCE TO RELATED APPLICATION

This application is a continuation-in-part of application Ser. No. 13/475,844, filed May 18, 2012 entitled APPARATUS AND METHOD FOR PRINTING SHARP IMAGE IN AN INKJET PRINTER by Wen Chen.

### FIELD OF THE INVENTION

The present invention relates generally to inkjet printing, and more particularly to printing on untreated textile media.

### BACKGROUND OF THE INVENTION

An inkjet printer typically includes a carriage holding a printhead thereon, a media driving system including a platen, and a print engine that has electronics including microchips to send out instructions for printing. The media driving system transports media, the printing substrate, in a media movement direction. The printhead has small nozzles thereon that can eject out tiny ink droplets following instructions received from the print engine. The carriage is capable of traveling back and forth along a carriage scanning direction, which is typically perpendicular to the media movement direction. As the carriage travels over the media driving platen, it defines a print zone where ink droplets ejected from the printhead will land. The combination of media movement and carriage movement ensures that ink droplets ejected from the printhead can land anywhere in a defined print area of the media to form an image. In an alternative implementation, instead of a printhead attached on a movable carriage, a page-wide and stationary printhead is assembled across the entire width of the media driving platen and ejects ink droplets onto the media on the platen as it moves passing the print zone.

In the past decades, inkjet printing has dominated many market segments. To achieve that, different types of inks and media have been developed. In recent years, inkjet printing has successfully penetrated the textile and fabric printing market. By definition, a textile is a material that made of interlacing textile fibers. And, a fabric refers to a material formed through knitting, spreading, weaving, bonding, or crocheting. However, the difference between textile and fabric is subtle and the two terms are often synonyms to each other. And in the context of this specification, textile is used to designate both materials, i.e., textile or fabric.

Comparing to other printing media, textile is characterized by the material it is made of the yarn that is constituted of natural or artificial fibers. During printing in an inkjet printer, when ink droplets land on the surface of a textile media, ink spreading is enhanced in the length direction of the fibers due to capillary action. Traditional textile priming uses thickened ink to limit the effect of capillary effect and to control ink spreading so that good print quality is achieved. As such ink is directly applied on untreated textile material.

For inkjet printing, low ink viscosity is required so that ink can be ejected through the tiny nozzles on the nozzle plate of the printhead. Low ink viscosity is also necessary for ink droplets to land on media to spread and form dots of proper size. However, printing, with low viscosity ink directly on untreated textile, causes image quality artifacts due to the effect of capillary action and uneven ink spreading, especially in an area where ink, load is high and dry time is long. The edges of text or color patches can become ragged and feathering. When two patches of different colors share a boundary, inter-color bleeding can happen. The consequence is degraded image quality.

To avoid the undesirable ink spreading on textile and the consequently unacceptable image quality, textile material is usually pre-treated with coating, before printing. In this way, image of sharp definition and smooth area can be achieved. U.S. Pat. No. 6,513,924 B2, issued to Ira Goldberg et al on Feb. 4, 2003, discloses an inkjet printer including a textile pretreatment device. The pretreatment device includes a sprayer to deposit a layer of pretreatment solution on untreated textile, followed by a heater to heat the textile and evaporate the excessive water. After that the treated textile media enters the printer for image printing. Ira Goldberg et al also discloses a post printing treatment step to add a coating, layer to protect the printed patterns against abrasion and fading.

The add-on equipment to pre-treat textile before printing in the Ira Goldberg et al patent can substantially increase the cost of making or maintaining the printer. Therefore, it is preferred to pre-treat textile materials as a separate process. However, commercially available textile pre-treatment equipment is costly in price and large in dimension. It is not unusual for a piece of textile pre-treatment equipment to take the space of a basketball court. And the pre-treatment process, including coating dispensing and drying, is energy consuming and labor intensive. In conclusion, media pre-treatment has become a burden to the digital textile printing industry.

Furthermore, pre-treated textile material usually has a rubber-like touch/feel sensation. To restore textile's original physical quality and touch/feel sensation, a post printing process is usually added to wash off the pre-treatment coating from the material. Such a process consumes extra energy and is unfriendly to the environment.

Therefore, it has been a desire in the inkjet printing industry to directly print on untreated textile media and to achieve sharp image quality. U.S. Pat. No. 8,459,788 B2, issued to Michelle N. Chretien et al on Jun. 11, 2013, discloses an ultraviolet (UV) curable, phase change ink that can stick to untreated plastic or textile media. The monomers and co-monomers in an UV curable ink, upon receiving UV light, cross-link to form a film on the media surface. As such, pigment particles or colorant molecules in ink are locked in the film that is adhered to the media, substrate to achieve color fastnesses and permanence. Direct printing on untreated textile can also be realized with latex ink, a representative pigmented ink that uses latex resin emulsion as binder. Upon printing, the water content is evaporated and the latex emulsion solidifies to a film that sticks to the media surface and locks in the pigment or colorant for color permanence. However, since pigment particles are not bonded to the textile fibers, such as in the applications of the traditional dye inks for textile, but instead are locked in a solid film that adheres to the media surface, the ink permanence on media cannot be compared to that of traditional textile ink printing. As time goes by, washing cycles or abrasions will wear out the ink coating and printed images will fade. Another drawback of UV curable ink, latex ink, or other types of pigmented inks, on textile is the undesirable rubber like touch/feel sensation, much like in the case of pre-treated textile media. And the coating formed by UV curable ink or latex ink cannot be washed off to restore the original quality and texture.

In conclusion, the desire to print on untreated textile media has been long felt and strong. But the only solution presently available is to use pigmented ink that results a solid film to be coated on the textile media with unsatisfactory color permanence performance and modified media touch/feel sensation. And all other solutions for digital printing on textile media require pre-coating. The market status is summarized in the article “Texting Printing” in The Big Picture magazine of the May 2013 issue.

Therefore, there is a need in inkjet printing to develop a method and a system to directly print on untreated textile media with sharp image quality, long image permanence and unmodified touch/feel sensation.

### SUMMARY OF THE INVENTION

It is therefore an object of the invention to provide a method and a system to directly print on untreated textile media in an inkjet printer to achieve sharp image quality without compromising image permanence and touch/feel sensation. The method comprises printing on an untreated textile media using a selected dye-based textile ink that has dye molecules with strong bonding to the textile fibers, and heating the textile media proximate the print zone to a predetermined temperature range to effectively dry the media at or immediately after printing.

According to one aspect of the invention, the dye-based textile ink is selected from a group consisting of reactive dye ink, acid dye ink, and disperse the ink, depending on the type of the untreated textile media to be printed.

According to another aspect of the invention, heating the textile media comprises heating the bottom surface of the media or heating the top surface of the media, or both. Heating media from the bottom surface is usually accomplished by conduction heating from a hot platen, which is heated by electrical or electromagnetic radiation heating means such as infrared or microwave heating. On the other hand, heating media from the top surface is usually achieved by noncontact means, i.e., hot air blowing/impingement or electromagnetic radiation such as infrared or microwave heating.

According to yet another aspect of the invention, a hot air blower is attached to the movable carriage traversing back and forth along the print zone to cause hot air impinging onto the media to heat the media and to remove ink moisture immediately after the ink droplets land on media.

According to yet another aspect of the invention, the method and system further comprises cooling the printhead by circulating a liquid coolant through a channel in a printhead plate conductively connected to the printhead, to remove heat energy from the printhead and to maintain the printhead temperature below a predetermined limit.

According to yet another aspect of the invention, the media driving system including a platen is an endless belt that has a gel-like adhesive layer thereon to hold and drive, untreated textile media so as to effectively eliminate textile stretching and distortion.

### BRIEF DESCRIPTION OF THE DRAWINGS

These and other objects and features of the invention will become more fully apparent from the following description and appended claims taken in conjunction with the following drawings, where like reference numbers indicate identical or functionally similar elements.

FIG. 1 is a partial perspective view of an example wide format inkjet printer with the front cover removed to show the important components for image printing;

FIG. 2 is a perspective view of the media heater shown in FIG. 1 with half of the outer shell removed to reveal the internal components;

FIG. 3 is a cross-sectional view of the blowing nozzle plate on the media heater in FIG. 2;

FIG. 4 is a partial cross-sectional view to show a blocking plate installed on the media heater in FIG. 1 to block air flow from passing to the other side of the blocking plate in order to limit heat transfer to the printhead;

FIG. 5 is a view of the printhead plate in FIG. 1, holding two printheads with nozzles showing, and with internal fluid channels to circulate printhead coolant in order to cool down the printheads.

FIG. 6 is a schematic of a refrigerator attached to the printer body to remove heat energy from the printhead coolant idler the coolant has circulated in the fluid channels in FIG. 5 for cooling down the printheads.

FIG. 7 is a perspective view of an endless belt driven by rollers as part of the media driving system. An infrared heater is shown to heat the belt from the bottom side.

FIG. 8 is a side view of the endless belt driven by rollers in FIG. 8, with a maintenance device to clean and dry the belt after textile media is separated and before in contact with textile media again.

### DETAILED DESCRIPTION OF THE INVENTION

The present description will be directed in particular to elements forming part of or cooperating more directly with, methods and system in accordance with the present invention. It is to be understood that elements not specifically shown or described may take various forms well known to those skilled in the art.

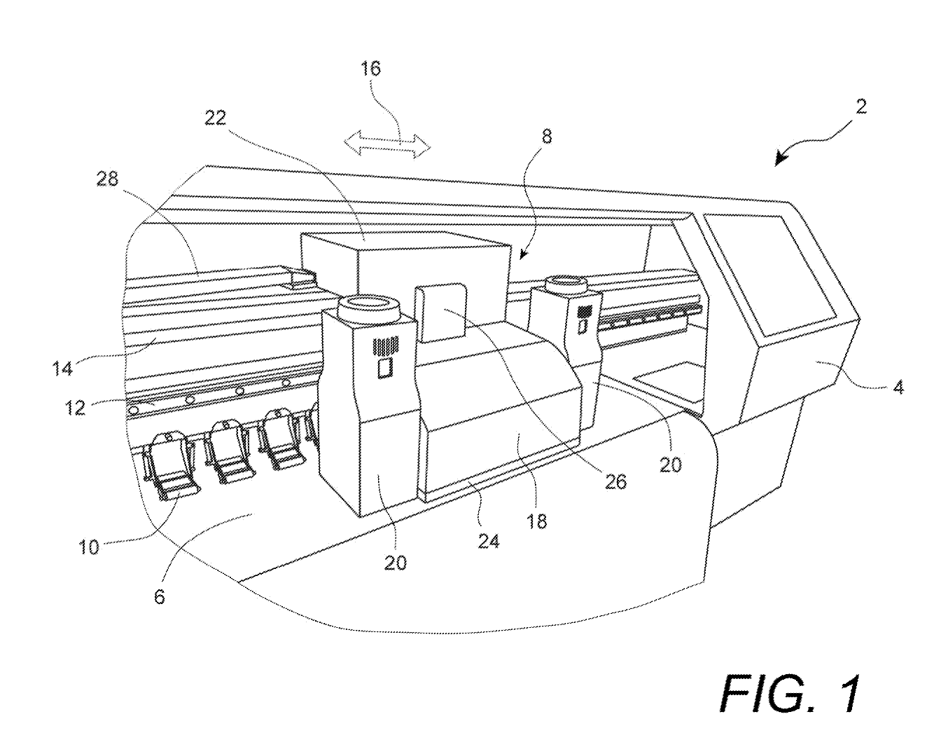

Referring to FIG. 1, an example of a wide format textile inkjet printer 2 is partially shown with the front cover removed to reveal the modules and components that are critical for printing an image. A wide format or large format inkjet printer is typically floor standing and is capable of printing on media larger than A2 or wider than 17″. In contrast, a desk-top or an office printer typically prints on media sized up to 8.5″ b 11″ or 11″ by 17″, or the metric standard A4 or A3. Printer 2 has right side housing 4 and a left side housing (not shown) to enclose various electrical and mechanical components, including a main PC board (not shown) and ink supplies of different colors (not shown), and to cam features therewith for operator interface and printing control. Many of these components are related to the operation of the printer, but not directly pertinent to the present invention.

As shown in FIG. 1, textile printer 2 has platen 6 adapted to provide an essentially flat area to support a textile media substrate (not shown). Platen 6 is coupled with a media driving means (not shown), including at least one motor, gears, shafts and rollers, to transport textile media at precision in a media moving direction that is from the rear end to the front end of the printer. A row of spring loaded pinch rollers 10 are attached to the primer frame to press down the textile media against a media drive roller (not shown) to move the media forward or backward. Platen 6 may include small holes distributed in the print zone that are channeled and connected to a vacuum source to cause suction to the underside of the media so that the media in the print zone provides an essentially flat area to receive ink during printing.

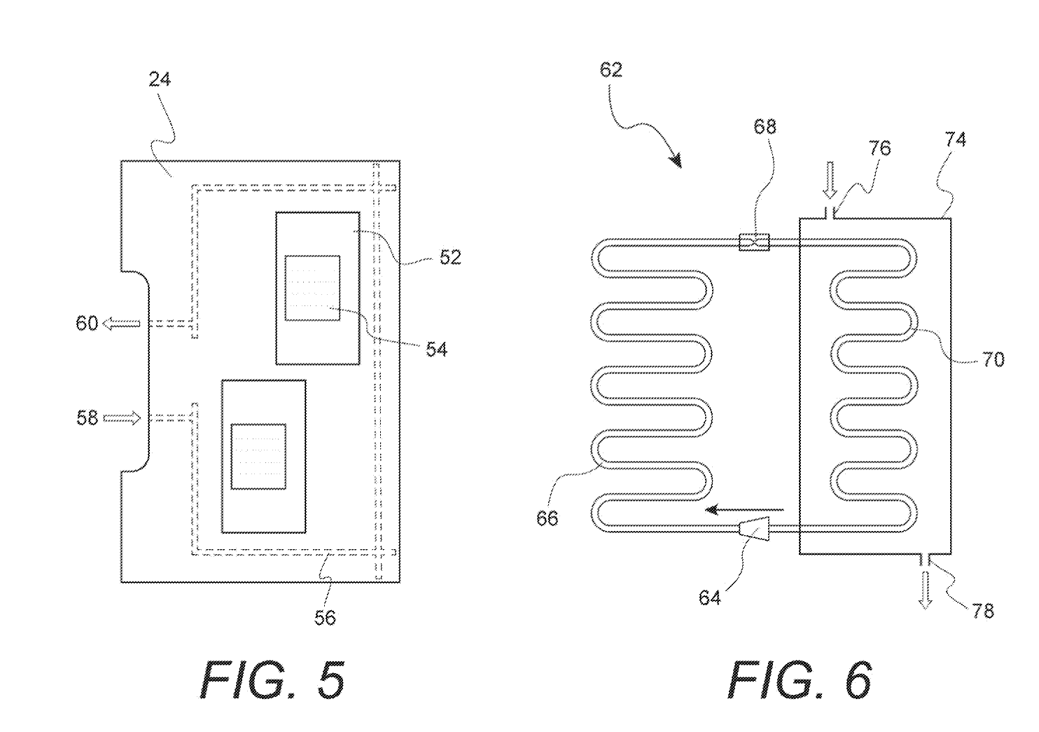

According to FIG. 1, carriage 8 rides on guiding rails 12 and 14, which can take different shapes such as shafts or bars, and bi-directionally traverses along scanning direction 16 from the left end to the right end of the printer. Carriage scanning direction 16 is essentially perpendicular to the media movement direction described in the previous paragraph. Carriage comprises printhead module 18, hot air blower 20, and carriage electronics box 22. Printhead module 18 further comprises a printhead plate 24 that includes one or a plurality of printhead 52 (as shown in FIG. 5). And, printhead 52 has nozzles 54 thereon (FIG. 5) capable of ejecting tiny ink droplets to land on the media immediately underneath the printhead to form an image. As carriage 8 traverses from end to end of printer 2 carrying printhead 52 printing, ink onto media over platen 6, a print zone on the platen is defined that is capable of receiving the ink droplets from the printhead. Carriage electronics box 22 contains a carriage PC board capable of receiving the electrical signals from the main PC board (not shown) and passing processed electrical signals to printheads in printhead module 18 through wires funneled in conduit 26 to control the printhead for printing.

Printhead 52 is typically from one of two types of technologies, thermal inkjet or piezoelectric inkjet. For thermal inkjet technology, a tiny electrical resistance heater, placed in a small fluid chamber under a nozzle, heats the ink in its proximity up to about 400° C., causing a small quantity of the ink to phase change into a steam bubble that raises the internal ink pressure sufficient for an ink droplet to be expelled out of the nozzle. For piezoelectric inkjet technology, an electric field is applied to a piezoelectric material possessing properties to create a mechanical strain in the material causing an ink droplet to be expelled. Lack of heat source to heat the ink and cause phase change, the piezoelectric inkjet typically imposes less restrictions on ink formulation.

When a printing job is sent from a remote computer (not shown) to printer 2 to print out an image, the main PC board that is stationarily attached to the printer body, preferably inside the left side or right side housing of the printer, compiles the image data from the remote computer into printer level instructions, including image data and power signals, and sends the signals to the carriage PC board residing in carriage electronics box 22, through flexible trailing cables carried inside flexible chain 28 which has an internal space along its length direction to house and protect components such as electrical flexible trailing cable and ink tubing. The electrical power and data signals are further compiled at the carriage PC board in carriage electronics box 22 to produce series of electrical pulses. And the electrical pulses are delivered to printhead 52 attached on printhead module 18 through electrical wires in conduit 26 to cause inkjet droplets to be selectively ejected out of nozzles 54 on printhead 52 following timing signals generated by a encoder reader (not shown) attached to carriage 8. Meanwhile carriage 8 moves along carriage scanning direction 16, and textile media is transported by the media driving means in the media movement direction. As such the ink droplets ejected from nozzles 54 land on predetermined locations on the top surface of the textile media to form an image according to the print job sent from the computer.

Alternatively, printer 2 can comprise a stationary and page-wide printhead attached to both end portions of the printer and cross over the entire width of media carrying platen 6. The length direction of the page-wide printhead is substantially perpendicular to the media movement direction. As such no movable carriage and carriage PC board is needed. A print zone is formed directly under the page-wide printhead and on the media passing by for image printing.

Preferably inks used in printer 2 have 4 subtractive colors, i.e., cyan, magenta, yellow and black, or more colors for image formation. As ink droplets are dispensed from nozzles 54, inks in the printheads are replenished from ink supplies stationarily attached to the printer body through flexible ink tubing running through the internal space of flexible chain 28 and conduit 26 to reach the printheads.

Aqueous inks have been developed to fit their applications, for example, for printing flags, banners, apparel fabrics, garments, technical textiles and point of purchase displays. An aqueous inkjet ink is environment friendly because it contains water as the main part of its composition. For the best overall quality of image printing on untreated textile substrates, including color brightness, wash fastness, halt fastness, and touch/feet sensation, dye-based ink is a better choice than pigment ink. And different types of dye-based inks find their best matches of textile substrates.

Reactive the ink is ideal for printing cotton, linen, silk, cotton and polyester blend, hemp, flax, and other plant derived fibers, such as rayon, jute, and viscose. A post-printing steaming process is required to cause the reactive dye to chemically bond to the textile fibers. As such the resultant image patterns on textile have good light fastness, wash fastness, as well as bright colors.

Another commonly used dye-based textile ink is acid dye ink, which is designed for printing on nylon, silk, wool, and leather, for producing sportswear, swimwear, lingerie, flags, banners ties, scarves, and etc. Similar to reactive dye ink, a post-printing steaming process is necessary for the acid the to chemically bond to the textile fabrics. Typically, the molecules are chemically bonded to protein or protein-like functional groups of the textile fibers. After the steaming process, the printed images possess excellent color brightness, light fastness, and wash fastness.

Polyester is a chemical that has very little affinity to large ionic dyes, and is very hard to be colored. Therefore, disperse dye has been developed for it. Disperse dye has small molecular weight with planar and non-ionic structure. When printed textile made of polyester is heated to a temperature of above 130° C., dye sublimation happens and the small dye molecules enter into the closely packed polyester chains and interact with polyester polymer functional groups. Normally, a post-printing dry heating process is required to cause the dye sublimation to happen and to achieve excellent light fastness and wash fastness.

For inkjet printing, ink needs to be ejected out of nozzles 54 on printhead 52 in FIG. 1. Therefore, inkjet ink is formulated to have low viscosity, typically within 2-5 cP and not exceeding 12 cP. To achieve proper ink spreading when ink droplets land on media surface, inkjet ink is also formulated to possess low surface tension, e.g. as low as 20 dyne/cm. When ink of low viscosity and low surface tension is printed on untreated textile substrate, however, uneven ink spreading happens because of enhanced capillary action along the length of the textile fibers, causing image artifacts, such as feathering, edge roughness, coalescence, inter-color bleeding, fussy image definition, and etc.

One way to solve this problem is heat up the textile substrate immediately after the ink droplets land on the surface of the media. In this way, the ink droplets are “frozen” to slow down or stop the spreading. As such sharp image with excellent quality can be achieved.

Media heating can be done in one or the combination of two approaches, heating the media from its underside, i.e., bottom surface heating, or from above, i.e., top surface heating. Bottom surface heating typically involves conductively transferring heat energy from platen 6 to the textile media transported thereon. Typically platen 6, or a part of it, is made of metal, preferably aluminum alloy that has high thermal conductivity. To achieve better thermal efficiency and to save energy, it is preferred to add structural insulation between platen 6 or the metal portion of it and the surrounding structures. An electrical resistance heater, such as a flexible tape heater or a wire heater, is conductively attached to the internal structure of platen 6 at the print zone to supply heat energy to the platen. Another type of heat source is an infrared (IR) heater, which can be attached to and heat up the platen. As another example, one or a plurality of IR bulbs can be buried in platen 6 at or before the print zone covering the whole media width, emitting IR radiation to heat textile media from the underside through openings or a thin layer that is transparent to IR spectrum.

Heating elements, including electrical resistance heater, infrared heater or another type, can also be attached to Platen 6 before the print zone to pre-heat the textile media, or after the print zone to post-heat the textile media. Each heating element can comprise a plurality of heaters. Since the print zone is generally a narrow area and print zone heating is generally short in time, pre-heating increases the media heating length and time so that media temperature at the print zone will reach a predetermined high value for printing. For the same reason, it may be important to continuously heat the media after the print zone because the remaining moisture in the printed image on media may cause migration and unwanted image quality artifacts. In this case, post-heating can be implemented. Different platen heating embodiments are disclosed in U.S. Pat. No. 8,186,797, U.S. Pat. No. 8,342,673, US2012/086753, US2012/147080, and US2012/162303.

In general, heating media from the top side is achieved through convection or radiation mean, but less likely through conduction means, because there exists limited contact to media from the top side. For one embodiment, a long and stationary hot air blower can be installed at ceiling of the inner space the top printer chassis above the print zone, covering the whole platen length, adapted to blow hot air downward and to convectively heat the media at or immediately after the print zone. Such an air blower can be found in U.S. Pat. No. 8,414,107, and US2012/086753. For another embodiment, a long electromagnetic radiation heater or a series of such heaters can be attached to the ceiling of the inner space of the top printer chassis above the print zone, covering the whole platen length, adapted to emit radiation to heat the media. The electromagnetic radiation heater can be an IR heater or a microwave heater. Pre-heating and post-heating can also be implemented to heat the top surface of media before the print zone and after the print zone.

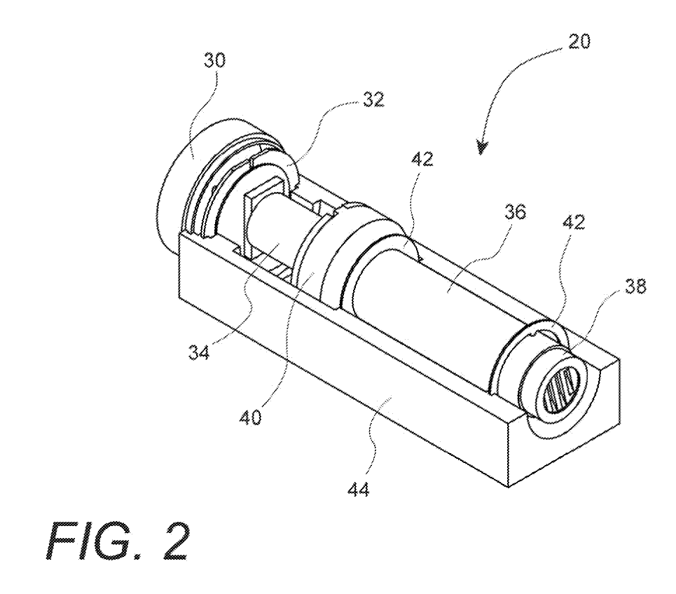

FIG. 2 depicts a hot air blower 20 as a preferred embodiment of heating the top surface of media as shown in FIG. 1. Hot air blower 20 comprises top cover 30, media heater PC board 32, fan module 34, heater module 36, and blowing nozzle plate 38. All of the components are tightly held in place in two halves of clam shells 44, which provide feature to assemble to movable carriage 8. In FIG. 2 the top half of the clam shell is removed and the components revealed. Fan module 34 is tightly held in place by fan module holder 40 to reduce vibration and to eliminate rattling; and heater module 36 is positioned with the help of holding rings 42, leaving an air gap to thermally insulate the heater module from the outer clam shells. Preferably the housing of heater module 36 is made of a material having low thermal conductivity, such as certain types of polymer plastics, to reduce heat loss due to conduction heat transfer. The heating element contained in heater module 36 can be an electrical resistance heater such as a nichrome wire coil, or a ceramic heater. Relying on IR radiation to transfer heat, a ceramic healer possesses the advantage of rapid and uniform heating. Media heater PC board 32 controls the fan power for desired blowing air flow rate and the heater power for desired blowing air temperature according to instructions generated from the main PC hoard. The flow rate and air temperature can be optimized to achieve the best results of removing moisture and drying ink.

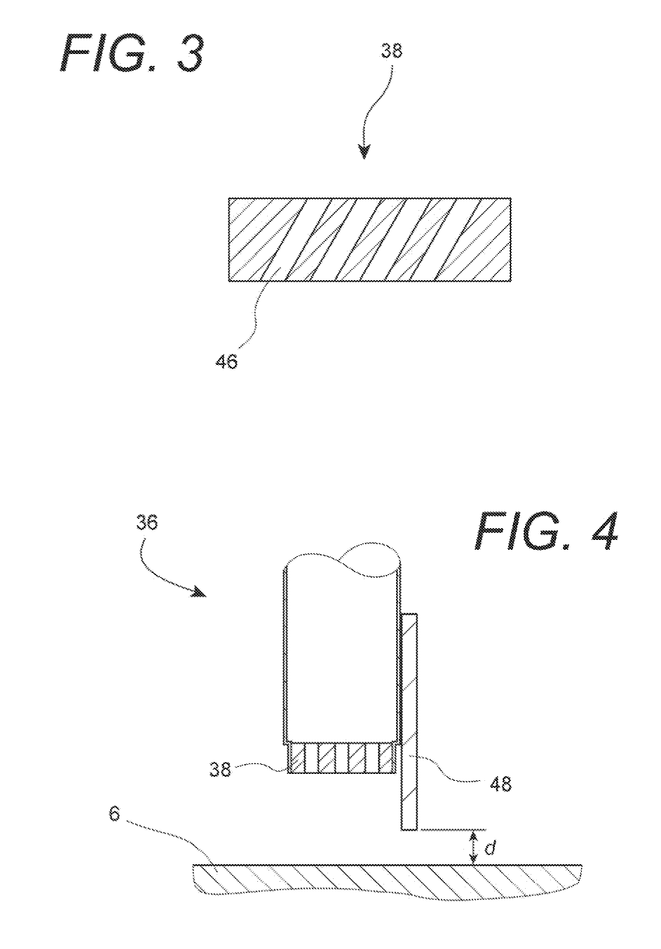

FIG. 3 depicts a cross-sectional view of blowing nozzle plate 38 of the hot air blower in FIG. 2. Slot blowing nozzles 46 are slanted, guiding hot air from hot air blower 20 to form a unidirectional flow on media. When hot air blower 20 is assembled to the carnage, blowing nozzles 46 are orientated so that the heated air flows away from printhead module 18. In the setup depicted in FIG. 1, hot air from hot air blower 20 attached to the left side of printhead module 18 is guided to flow toward the left end side of the printer, and hot air from hot air blower 20 attached to the right side of printhead model 18 is guided to flow toward the right end side. Another embodiment to guide hot air flow is shown in FIG. 4, where blocking plate 48 is installed between hot air blower 20 and printhead module 18. Further, hot air blower 20 is assembled to the carriage 8 in a way to leave a gap between blowing nozzle plate 38 and platen 6 that is substantially larger than distance d shown in FIG. 4. Therefore, when hot air is blown out of blowing nozzles 46 of hot air blower 20, the airflow is blocked by blocking plate 48 and is forced to flow in the direction away from printhead module 18. An alternative of the implementation in FIG. 4 is to make blowing nozzle plate 38 and blocking plate 48 in one piece so that the design is simplified.

Hot air blower 20 can be arranged on movable carriage 8 in different manners. As shown in FIG. 1, two media heaters are assembled, one on the left side of printhead module 18, and the other on the right side. This arrangement allows even sequencing and uniform heat distribution for bi-directional printing, because for printing both left-to-right and right-to-kit there is a leading heater and a trailing heater for the printing swath. For unidirectional printing, however, the two media heaters arrangement has the advantage of double the heating power. A second arrangement is to assemble one hot air blower 20, instead of two, either to the tell side or to the right side of printhead module 18. In this way, heating sequence and distribution for bidirectional printing is not as ideal as the previous arrangement. But the width of carriage 8 can be made shorter, and so is the width of printer 2. Shorter printer width saves printer cost and the standing space for printing operation. A third arrangement is to place one or a plurality of hot air blowers 20 at the front side of carriage 8, opposite to the side that carriage g is slidably attached to guiding rails 12 and 14. This third arrangement has the shortest carriage width and therefore the shortest printer width. However, there is a short time delay between printing ink droplets on textile media and heating of the ink droplets because the media heater is located slightly away from the print zone. And the short time delay max compromise image quality depending on the ink and textile media combination in use.

For the embodiment of page-wide printhead, there is no movable carriage 8. As such, hot air blower 20, or a plurality of such blowers, is preferably attached to the front side of the printhead. Without swathing during printing, a printer with page-wide printhead prints much faster than one with a swathing carriage. Therefore, the short distance between the print zone and where the impinging air lands does not cause much time delay and is not a concern for image quality degradation. Another implementation is to attach hot air blowers 20 to the back side of the page-wide printhead for pre-heating immediately before printing.

Hot air blower 20 in FIGS. 1 and 2 is merely an example of attaching a media heater to movable carriage S or printhead module 18. There exist many other implementations, including different heat sources and heating methods, to achieve essentially the same purpose of heating media and drying ink printed thereon. For example hot air blower 20 can be replaced by an electromagnetic radiation heater, such as a microwave heater radiating microwave energy or an IR heater emitting IR light.

The strong tendency of ink spreading on textile media requires effective means to heat up the media and remove moisture immediately after ink droplets land on media. A combination of heating methods may be necessary for the purpose. For example, pre-heating of textile media may be necessary to heat the media to a certain temperature before it enters the print zone. Preferably, the pre-heating is achieved through bottom surface heating as described in previous paragraphs. At the print zone, the textile media is heated by bottom surface heating and top surface heating. And the top surface heating is preferably by hot air blower 20 on movable carriage 8 as shown in FIG. 1. After the print zone, the textile media is heated through bottom surface heating or top surface heating, or both, in order to further remove the remaining moisture for superb image quality. Different heating methods and different heating zones, including pre-heating, print zone heating, and post-heating, can be selected and implemented according, to requirements.

The time interval between ink lands on media surface and its evaporation from the media is called ink dry time. The shorter the dry time, the faster the ink droplets to freeze their size and shape. Ink dry time is dependent on the heating power and heating methods. Top surface heating and bottom surface heating may impose significant differences. The bottom surface of the media rides on the printer platen. Therefore, conduction heating is the primary means for bottom surface heating. In general high heating temperature, for example, platen temperature, is required to transfer heat energy through the media. Therefore, by means of bottom side heating alone, e.g., platen heating, media temperature on the top surface at the print zone needs to be above 50° C., and preferably above 70° C. for printing untreated textile. On the other hand, top surface heating is usually non-conductive because of the limited media contact, and convection, including natural convection and forced convection caused by carriage movement or blowing air, may play a significant role to remove water moisture. When blowing hot air is impinged on the top surface on media, for example, it causes convective heat transfer and convective mass transfer simultaneously. The heat transfer heats up the media; the mass transfer removes the moisture from the media surface. Because evaporation takes away energy, removing moisture effectively suppresses media temperature rise. Therefore, for untreated textile printing with top surface heating alone, media temperature on the top surface of media at or immediately after the print zone needs to be above 40° C.

For top surface heating, an embodiment such as hot air blower 20 in FIG. 1 normally enjoys higher energy efficiency as compared to a heater attached to the ceiling of inner space of the printer chassis, because hot air blower 20 brings impinging air right to the media surface, thus maximizing convection coefficient in the impingement area. However, heating is localized to small areas so that average media temperature remains low. Attaching an electromagnetic radiation heater to the carriage or printhead module has the same effect of heating local areas of media.

There exist optimal combinations of ink, media and heating configuration for the best image quality and permanence, and energy consumption. In general, aqueous dye-based inks for textile contain about 2-7% of dye, and 30-90% of water by weight. Other components include co-solvents, humectants, and etc. Since the heating and drying process is to evaporate out water and other co-solvents, the dye component does not play a significant role. Therefore, the drying efficiency is determined by content of water and co-solvents in the ink, and not by the type of dye it contains, whether it is reactive dye, acid dye, or disperse dye.

Another important factor to determine drying efficiency is the textile substrate type and thickness. In general, the more the substrate can absorb and hold water moisture, the less tendency ink will spread laterally to cause image quality artifacts, such as inter-color bleeding and edge feathering. Thus, less heating and is needed to dry the ink in the textile substrate for sharp images. For example, a textile substrate made of cotton is more absorptive than one made of silk. Therefore the cotton textile requires less heating than the silk textile to properly dry to keep good image quality. For the same textile material, thicker media can absorb and hold more ink, and therefore requires less heating.

As such, media heating and drying configuration for printing untreated textile needs to be determined according to ink formulation, primarily water and co-solvent content, and the textile media type and thickness. Preferably, printer 2 in FIG. 1 provides optimal choices for a printer operator to select according to the combination of ink formulation, textile type and thickness. The following are a few examples of the heating and drying configurations provided by an inkjet textile printer having bottom surface heating through platen and hot air blowers attached to a movable carriage.
a. Directly printing disperse dye ink on untreated 80 gram/m² polyester substrate. For printing, turn on platen pre-heater before the print zone and the platen print zone. And turn on the carriage hot air blowers to impinge hot air at 340° C. with high air velocity. Media temperature in the print zone is 80° C. After printing, the textile is baked in an oven at 240′C for dye sublimation.
b. Directly printing disperse dye ink on untreated 180 gram/m² polyester substrate. The thicker polyester tends to absorb more ink, so less heating is needed for equivalent image quality. For priming, turn on the carriage hot air blowers to impinge hot air at 340° C. with high air velocity. No platen heating. Media temperature in the print zone is 40° C. After printing, the textile is baked in an oven at 240° C., for dye sublimation.
c. Directly printing disperse dye ink on untreated 180 gram/m² polyester substrate. For printing, turn on platen pre-heater before the print zone and the platen print zone. No hot air blowing. Media temperature in the print zone is 90° C. After printing, the textile is baked in an oven at 240° C. for dye sublimation.
d. Directly printing reactive dye ink on untreated 150 gram/m² cotton substrate. For printing, turn on platen pre-heater before the print zone and the platen print zone. And turn on the carriage hot air blower to impinge hot air at 340° C. with high air velocity. Media temperature in the print zone is 65° C. After printing, the textile is steamed for dye to textile bonding.
e. Directly printing acid dye ink on untreated 70 gram/m² silk substrate. For printing, turn on platen pre-heater before the print zone and the platen print zone. And turn on the carriage hot air blowers to impinge zone is 80° C. After printing, the textile is steamed for dye to textile bonding.

As described in the examples above, it is important to have a post printing baking or steaming process to cause the dye molecules to bond onto the textile fibers. As such, excellent wash fastness, and bright color quality can be achieved. The baking or steaming process can be a performed in an apparatus just downstream of the print zone in the printer. Or, it can be a process on a separate apparatus after the printing job is done.

Media heating and dying before and at the print zone, especially when the heating flux is high for rapid ink drying, inevitably causes printhead to heat up even with the best insulation and hot air flow guiding arrangements, such as those shown in FIGS. 3 and 4. Printhead 52 is typically 1-2 mm away from the top surface of media. At such a close proximity, heat from the media is transferred to printhead 52 through convection and radiation. Higher media temperature in the print zone therefore causes printhead temperature to go higher. Thus ink in nozzles 54 evaporates and dries at a faster speed and clogged nozzles can happen. Therefore, it is imperative to provide solutions to prevent nozzles 54 from drying and to be clogged.

Proper printhead service routines need to be implemented to maintain nozzle healthiness, including spitting ink droplets from nozzles, vacuum or pressure priming, wiping nozzle plate, and etc. Higher printhead temperature usually means increased frequency and intensity of nozzle cleaning servicing, and will affect productivity and waste more ink. When printhead temperature is too high, for example, 70° C. or higher, printhead servicing alone may not do the job.

One solution to counter the nozzle drying issue is to add more high boiling; point and low volatile components, or the so called humectants, in the ink to reduce evaporation. The type of humectants can be selected from a group consisting of mono butyl ether, 2-pyrrolidone, Dantocol ethylene glycol, diethylene glycol, triethylene glycol, tetraethylene glycol, propylene glycol, polyethylene glycol, polypropylene glycol, 2-pyrrolidone, 2-methyl-1,3-propanediol N-methyl-pyrrolid-2-one, 1,3-dimethyl-imidazolid-2-One, octyl-pyrrolidone, N-methyl pyrrolidone, sulfonated polyethylene oxide, and etc. Nevertheless, as the content of humectants and solvents goes higher, the ink becomes less healthy and less environment friendly.

Another solution is to maintain the printhead temperature so that it is below an upper limit for optimal nozzle performance. At room temperature, the dried ink is quickly dissolved by the ink solvent and co-solvents in the nozzles, and nozzles 54 (FIG. 5) will stay unclogged and alive. Above certain printhead temperature, though, ink diving in the nozzles cannot be quickly dissolved, and the consequence is clogged nozzles that lead to poor image quality. For the ink, media and heating combination in this invention, the upper printhead temperature limit is 70° C., and preferably 50° C.

A first order improvement for printhead temperature control is to include an insulation layer between hot air blower 20 and printhead module 18. In FIG. 1. When media heating power is high to dry high load aqueous ink on untreated textile media, for example, advanced method needs to be adopted. FIG. 5 shows an embodiment for printhead temperature control by circulating a liquid coolant in a conductive printhead plate 24 that is in contact with printhead 52. Printhead plate 24 is made of a material having high thermal conductivity, for example aluminum, to take heat energy from printhead 52 through conduction. To effectively dissipate heat out of printhead 52, a substantially large contact area between printhead plate 24 and printhead 52 is needed. In FIG. 5, printhead plate 24 is implemented in such a way to embrace the perimeter of printhead 52 for maximal contact area. Conductive adhesive can be applied to the interface between printhead plate 24 and printhead 52 to further increase conduction heat transfer. A fluid channel 56 is built inside printhead plate 24 to circulate a coolant to cool down the plate, and consequently keep the temperature of printhead 52 from going too high. Fluid channel 56 can be drilled in a solid piece of printhead plate, or it can be formed by sandwiching two thin plates together.

The coolant running through fluid channel 56 inside printhead plate 24 can be water directed from a water outlet inside the building where printer 2 is located. Or, the coolant can come from a water container. Preferably, the water in the container is kept at substantially constant temperature. For example, the container can hold ice and water to keep the water temperature effectively at 0° C. The coolant is pumped through a first flexible tubing running inside flexible chain 28 and carriage conduit 26 to reach printhead plate 24, entering fluid channel 56 from coolant inlet 58. After circulation in fluid channel 56, the coolant leaves printhead plate 24 from coolant outlet 60, returning to the off-carriage coolant supply a second flexible tubing running inside carriage conduit 26 and then flexible chain 28.

FIG. 6 reveals another embodiment to maintain printhead coolant temperature by a refrigeration means located off movable carriage 8 and attached to the printer body. The refrigeration coolant for the refrigeration means goes through compressor 64 to be compressed to a higher pressure and an elevated temperature, condenser 66 to cool down and get condensed to liquid state, then expansion valve 68 to reduce pressure and to a lower temperature. After that the refrigeration coolant enters into the printhead coolant supply container 74 and runs through evaporator 70 to absorb heat from the printhead coolant that enters into printhead coolant container 74 at inlet 76 and leaves the container at outlet 78.

The printhead coolant in supply container 74 is pumped through a first flexible tubing running inside flexible chain 28 and carriage conduit 26 to reach printhead plate 24, entering fluid channel 56 from coolant inlet 58. After circulation in fluid channel 56, the coolant leaves printhead plate 24 from coolant outlet 60, returning to the off-carriage coolant supply container 74 through a second flexible tubing running inside carriage conduit 26 and then flexible chain 28.

Many other methods can be appreciated by one of ordinary skill in the art to cool down the printhead coolant off movable carriage 8. One alternative embodiment for cooling down the printhead coolant in FIG. 5 is to pump the coolant from coolant outlet 60 to a firmed or pinned heat sink positioned on carriage 8, for example, on top of carriage electronics box 22, and to cool the heat sink with the wind caused by the moving carriage, or by a fan attached to the heat sink. Another alternative is to select a coolant that can evaporate and condense in the printer operation temperature range and to allow the coolant to go through a refrigeration cycle in order to bring heat out of the printhead on movable carriage 8. Unlike the apparatus in FIG. 6, the refrigeration cycle in this case happens on the movable carriage. That is, the coolant evaporates at the printhead to absorb heat, then is compressed to cause the coolant temperature to rise, followed by condensation located away from the printhead but on carriage 8. Before going back to the printhead, the coolant goes through an expansion valve to reduce pressure and temperature.

Another challenge of printing untreated textile media is media stretching and distortion. Untreated textile is usually too flexible to keep its shape. Pre-coating textile increases its stiffness that is friendly to printing and handling. Or, a backing layer is added for printing without stretching and distortion. Adding a backing layer, however, causes wastes and more work to peel off the layer after the printing job is done.

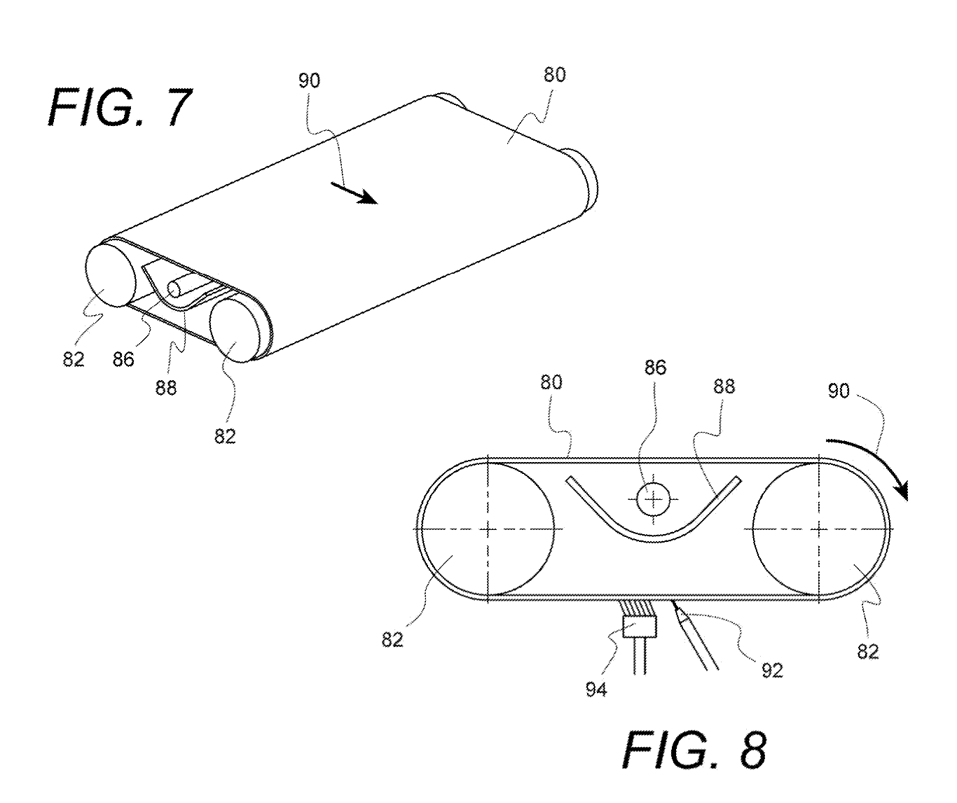

An endless belt is illustrated in FIGS. 7 and 8 as an embodiment of platen 6 and the media driving system in FIG. 1 to the untreated and un-backed textile media in its original shape during printing so that the end image is without distortion. As shown in FIG. 7, endless belt 80 is driven by two or a plurality of rollers 82 to run in the media movement direction 90. And rollers 82 are driven by a motor (not shown) directly or through transmission means. Rollers 82 cause tension to endless belt 80, so that substantially flat platen surface is provided to receive the untreated textile on top for printing.

To eliminate textile stretching and distortion, a thin layer of gel-like adhesive (not shown) is added to the surface of endless belt 80. When untreated textile media is fed onto endless belt 80, the adhesive layer on the belt sticks to the bottom side of the media and stops it from moving around during conveyance and printing. As such the media is kept in its original shape and dimension. The adhesive layer also has the advantage of keeping the textile media low so that the nozzle plate on the printhead stays away from the media during printing. Another advantage of endless belt 80 with an adhesive layer is that the excessive ink load is transferred from media to the adhesive layer during printing so that ink bleeding and feathering is avoided. This is especially true for printing thin textile media that has less capability to absorb ink. An alternative of the adhesive layer is to suck the textile media onto the endless belt. For example, endless belt 80 can contains many small through holes thereon, and a vacuum source can be applied under the belt to suck the media onto the belt through the holes during transportation and printing. The vacuum source can also help to remove excessive ink from the media.

FIGS. 7 and 8 also show an IR heater 86 to heat the belt from its underside. An IR radiation reflector 88 is placed under IR heater 86 to reflect the IR radiation from the heater toward the belt. Other heating methods can be implemented. For example rollers 82 can be designed to have proper electrical resistance and can be heated up by applying electricity directly to them.

In FIG. 8 a device for cleaning endless belt 80 is illustrated. Nozzle 92 and wiper 94 are placed at a location at the proximity of the endless belt module, after the textile media is separated from endless belt 80 and before endless belt 80 contacts fresh textile media again. Nozzle 92 sprays a liquid cleaner onto the adhesive layer of endless belt 80. And wiper 94 wipes of the liquid and the ink residue to effectively clean the adhesive layer for another cycle of media transporting and image priming. Preferably, wiper 94 includes a vacuum means to suck the liquid and residue ink away. Nozzle 92 can be a plurality of nozzles, and wiper 94 can be a plurality of wipers.

It is understood that the above-described invention is merely illustrative of the possible specific embodiments which may represent principles of the present invention. Other arrangements may readily be devised in accordance with these principles by those skilled in the art without departing from the scope and spirit of the invention.

1. A method for printing untreated textile in an inkjet printer, comprising the steps of
feeding an untreated textile media by a media driving system having a platen therewith, the platen forming a print zone, the textile media being transported on the platen;
printing an image on the untreated textile media with a printhead held over the platen, the printhead being capable of dispensing an aqueous dye-based textile ink in the print zone the aqueous dye-based textile ink being selected from a group consisting of reactive dye ink, acid dye ink, and disperse dye ink; and
heating the untreated textile media proximate the print zone so that the media temperature in the print zone is above a media temperature limit.

2. A method as recited in claim 1 wherein:
the aqueous dye-based textile ink is reactive dye ink, and the untreated textile media is selected from a group consisting of cotton, cotton blend, linen, silk, hemp, flax, rayon, jute, and viscose.

3. A method as recited in claim 1 wherein:
the aqueous dye-based textile ink is acid dye ink, and the untreated textile media is selected from a group consisting of nylon, silk, wool, and leather.

4. A method as recited in claim 1 wherein:
the aqueous dye-based textile ink is disperse dye ink, and the untreated textile media is selected from a group consisting of polyester, polyester blend, and acrylic.

5. A method as recited in claim 1 wherein:
the step of heating the untreated textile media, proximate the print zone includes top surface heating, and wherein the media temperature limit is 40° C.

6. A method as recited in claim 1 wherein:
the step of heating the untreated textile media proximate the print zone includes top surface heating, and wherein the media temperature limit is 70° C.

7. A method as recited, in claim 5 wherein:
the top surface heating is by means of at least one hot air blower.

8. A method as recited in claim 7 wherein:
the at least one hot air blower is attached to a movable carriage carrying the printhead thereon, the movable carriage being adapted to travel back-and-forth along the print zone over the platen.

9. A method as recited in claim 7 wherein:
the at least one hot air blower is attached to a page-wide printhead module stationarily held across the entire length of the platen.

10. A method as recited in claim 5 wherein:
the top surface heating is by means of at least one electromagnetic radiation heater.

11. A method as recited in claim 1 wherein:
the step of heating the untreated textile media proximate the print zone includes bottom surface heating, and wherein the media temperature limit is 50° C.

12. A method as recited in claim 1 wherein:
the step of heating the untreated textile media proximate the print zone includes bottom surface heating, and, wherein the media temperature limit is 70° C.

13. A method as recited in claim 1, further comprising the step of:
circulating a coolant through a channel in a printhead plate conductively attached to the printhead so as to control the printhead temperature.

14. A method as recited in claim 13 wherein:
the printhead temperature is controlled below 50° C.

15. A method as recited in claim 1 wherein:
the media driving system having a platen therewith includes an endless belt driven by a plurality of rollers, the endless belt having a means for holding the untreated textile media thereon, the endless belt providing a substantially flat surface in the print zone.

16. A method as recited in claim 15 wherein:
the means for holding the untreated textile thereon is a layer of gel-like adhesive attached to the surface of the endless belt, the gel-like adhesive layer adapted to be cleaned after separating from the printed textile media and before contacting fresh textile media for the next cycle.

17. A method as recited in claim 15 wherein:
the means for holding the untreated textile thereon is a sucking force provided by a plurality of small through holes in the belt coupled with a vacuum source.

18. A method as recited in claim 1, further comprising the step of heating the untreated textile media after the print zone.

19. An inkjet printer for printing an untreated textile media, comprising:
a media driving system including an endless belt driven by a plurality of rollers, the media adapted to be transported on the top surface of the endless belt, the endless belt having a layer of gel-like adhesive attached thereon adapted to cling to the untreated textile media, the gel-like adhesive layer adapted to be cleaned after separating from the printed textile media and before contacting fresh textile media for the next cycle;
a printhead held over the endless belt and adapted to dispense ink droplets for image formation in a print zone on the endless belt, the ink being an aqueous dye-based textile ink selected from a group consisting of reactive dye ink, acid dye ink, and disperse dye ink;
at least one heater adapted to heat up the untreated textile media before and in the print zone so that the media temperature in the print zone is above a media temperature limit; and
a printhead temperature maintenance device adapted to circulate a coolant through a channel in a printhead plate conductively attached to the printhead.

20. An inkjet printer as recited in claim 19 wherein:
the at least one heater includes at least one top surface heating heater, and wherein the media temperature in the print zone is above 70° C.
